(19) United States
(12) Patent Application Publication
(10) Pub. No.: US 2025/0221573 A1
(43) Pub. Date: Jul. 10, 2025

(54) A DEVICE FOR GRINDING AND FILLING

(71) Applicant: G&E Innovations Inc., Las Vegas, NV (US)

(72) Inventors: Gustavo Reyes, Las Vegas, NV (US); Esther Delgado-Lago, Las Vegas, NV (US)

(21) Appl. No.: 18/684,652

(22) PCT Filed: Aug. 19, 2022
(86) PCT No.: PCT/US2022/040970

§ 371 Date: Feb. 16, 2024

Related U.S. Application Data
(60) Provisional application No. 63/268,589, filed on Feb. 25, 2022.
(60) Provisional application No. 63/235,086, filed on Aug. 19, 2021.

(51) Int. Cl. A47J 42/40; A24B 7/06; A47J 42/26

(52) U.S. Cl. CPC A47J 42/40; A24B 7/06; A47J 42/26

(57) ABSTRACT

The invention disclosed herein relates generally to appliances, and more specifically to devices, systems, and methods for grinding a material and filling a receptacle with ground material.

This application claims priority to U.S. Provisional Application Ser. No. 63/235,086, filed Aug. 19, 2021 and U.S. Provisional Application Ser. No. 63/268,589 filed Feb. 25, 2022, each of which is hereby incorporated by reference in its entirety.

### TECHNICAL FIELD OF THE INVENTION

The present application relates generally to appliances, and more specifically to devices, systems, and methods for grinding a material and filling a receptacle with ground material.

### BACKGROUND TO THE INVENTION

Herbs, spices, coffee, tobacco, cannabis, mushrooms, and other plant materials can be ground or shredded prior to use. For example, coffee beans, tobacco and cannabis are often broken down, either by hand or using a grinder, prior to consumption. In the case of cannabis, when broken down by hand, the resulting cannabis product is often lumpy, which can cause uneven distribution of cannabis in a joint or bowl. Due to the sticky nature of cannabis, breaking down cannabis by hand typically causes substantial amounts of cannabis to stick to the fingers. Tobacco and cannabis grinders are often used to create a more evenly distributed product that burns more consistently. Both manual and electric grinders are used to grind raw cannabis.

Ground tobacco or cannabis is often wrapped in rolling paper to be smoked. Often, pre-formed cones made with rolling paper are stuffed or packed with tobacco or cannabis that has been ground. Cigarettes and pre-rolled cannabis joints are generally manufactured in mass quantities using large machinery, however, some consumers prefer to prepare their own cigarettes or joints by grinding tobacco or cannabis and packing pre-rolled paper tubes or cones with the ground tobacco or cannabis.

Many coffee makers use “pods” filled with ground coffee beans that a user simply inserts into a coffee machine to brew coffee. Pre-packed coffee pods are typically manufactured in bulk in factories using large machinery, however, some coffee enthusiasts prefer to grind their own coffee beans and prepare their own coffee pods at home.

Many herbs and other plant matter, such as mushrooms, is sold in capsule form to be consumed as a dietary supplement. Most capsules are manufactured in bulk by manufacturers using large machinery. However, some consumers prefer to grind their own plant medicine and prepare their own dietary supplements in capsule form.

Devices that exist in the art face a challenge when it comes to loading or filling ground material into a receptacle. Depending on the nature and size of the ground material, it can be difficult to obtain an even fill without requiring a means for packing the material down into the receptacle. For example, cannabis is sticky and can stick to the sides of the receptacle or to other ground cannabis particles thereby creating uneven distribution of cannabis in the receptacle. It is important to obtain a firm and uniform distribution of cannabis in a receptacle, such as a cone, to enjoy a smooth and even smoke. Packing a cone too loosely will not get enough cannabis in the cone will burn too quickly and/or unevenly, and packing a cone too tightly will result in restricted airy flow, making it difficult to smoke. Most devices known in the art require the use of a tamping tool, or a blender, or mixer, or spreader, or vibration to obtain an even distribution of ground material in the receptacle.

There is a need in the art for a device for grinding plant matter or other similar substances and loading, filling, or packing the ground material into a desired receptacle, such as, into a pre-formed cigarette or cone, a pod, a capsule, or the like, in a manner that obtains an even distribution of ground material in the receptacle.

### SUMMARY OF THE INVENTION

The invention disclosed herein relates to combination grinding and filling device. In some embodiments, the device includes a grinder portion and a reservoir portion. In some embodiments, the grinder portion has one or more cutting means and can be removably attached to the reservoir portion. In some embodiments, the reservoir portion is adapted to hold a desired receptacle to be filled with a ground material received from the grinder portion.

In some embodiments, the device further includes a filter portion removably attached between the grinder portion and the reservoir portion. In some embodiments, the device is a handheld device. In some embodiments, the device is not a handheld device but is a portable device.

In some embodiments, the grinder portion is cylindrical in shape. In some embodiments, the largest diameter of the grinder portion is less than 5 inches, or less than 4 inches, or less than 3 inches.

In some embodiments, the one or more cutting means of the grinder portion include one or more ball-and-chains, or one or more chains, or one or more blades, or one or more teeth. In some embodiments, the grinder portion includes an electric motor.

In some embodiments, the receptacle to be filled with ground material is a pre-formed cone.

In some embodiments, the device does not comprise a tamper, or a blender, or a mixer, or a spreader, or vibration means, or other similar packing tool for uniformly distributing ground material in the receptacle.

In some embodiments, the reservoir portion is adapted to hold two or more desired receptacles. In some embodiments, the reservoir portion is adapted to hold three or more desired receptacles. In some embodiments, the reservoir portion is adapted to hold four or more desired receptacles. In some embodiments, the reservoir portion is adapted to hold five or more desired receptacles. In some embodiments, the reservoir portion is adapted to hold six or more desired receptacles. In some embodiments, the reservoir portion is adapted to hold a plurality of desired receptacles.

In some embodiments, the invention disclosed herein is drawn to methods of grinding a starting material and filling a receptacle with ground material. In some embodiments, the method includes: obtaining a starting material to be ground; placing the starting material in the grinder portion of the device disclosed herein; placing a desired receptacle into the reservoir portion of the device disclosed herein; removably attaching the reservoir portion to the grinder portion; positioning the grinder portion such that the one or more cutting means contact the starting material; activating the grinder portion to cause rotational or reciprocal motion of the one or more cutting means within the grinder portion; disengaging the reservoir portion from the grinder portion; and removing the receptacle filled with ground material.

In some embodiments, the method further comprises removably attaching a filter portion between the grinder portion and the reservoir portion, wherein the starting material is placed between the grinder portion and the filter portion.

In some embodiments, the device of claim 1 is a handheld device.

In some embodiments, the rotational or reciprocal motion of the one or more cutting means within the grinder portion creates a vortex in the device that facilitates movement of ground material from the grinder portion to the receptacle in the reservoir portion. In some embodiments, the vortex uniformly and evenly distributes ground material in the receptacle without the need for a packing means, such as, a tamper, or blender, or mixer, or spreader, or vibration means.

In some embodiments, activating the grinder portion results in grinding of the starting material and filling of the receptacle in the reservoir with ground material substantially simultaneously.

In some embodiments, the receptacle is a pre-formed cone. In some embodiments, the pre-formed cone is filled with ground material without the need for an additional or separate packing means.

In some embodiments, the methods further include tapping the device on a hard surface to dislodge the receptacle prior to removing the receptacle from the reservoir portion.

In some embodiments, a grinder comprising one or more of the features of the description herein is provided. In some embodiments, a method comprising one or more of the features of the description herein is provided.

### BRIEF DESCRIPTION OF THE DRAWINGS

FIGS. 1-5 depict various views (perspective, front, back, left, and right) of an embodiment of the device including an optional filter portion 200 in an assembled state.

FIG. 6 depicts a top view of an embodiment of the device in an assembled state.

FIG. 7 depicts a bottom view of an embodiment of the device in an assembled state.

FIG. 8 depicts a top perspective exploded view of the device in an unassembled state.

FIG. 9 depicts a bottom perspective exploded view of the device in an unassembled state.

FIG. 10 depicts various cones that can be used with the invention described herein.

FIG. 11 depicts various blades that can be used with the invention described herein.

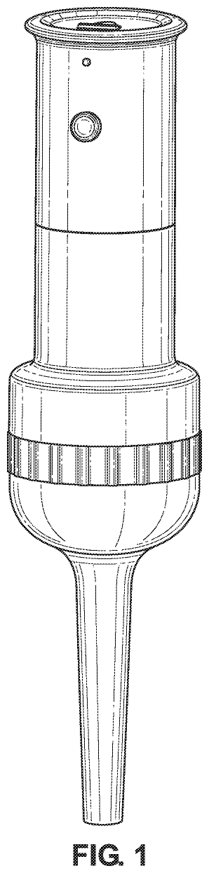

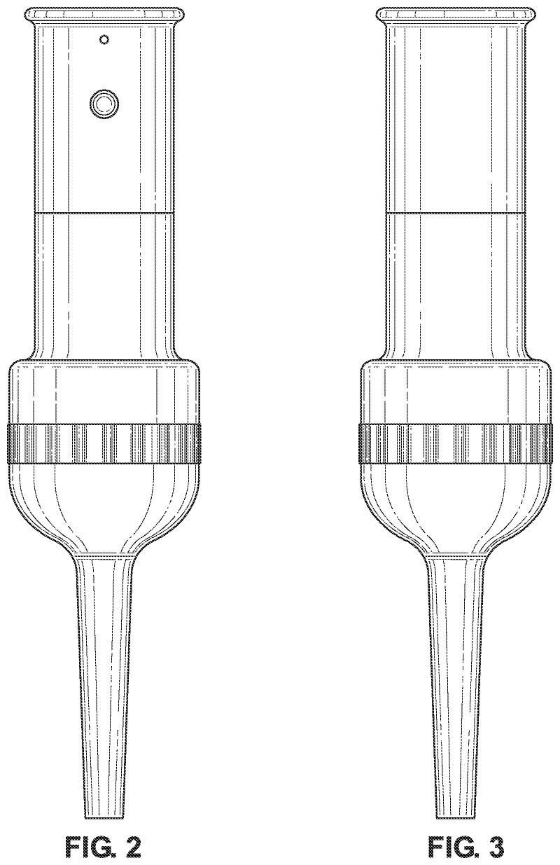

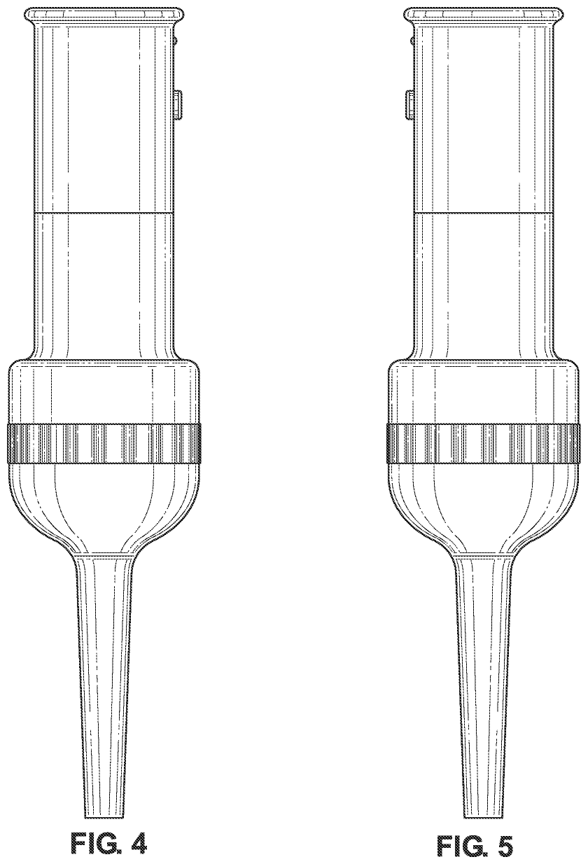

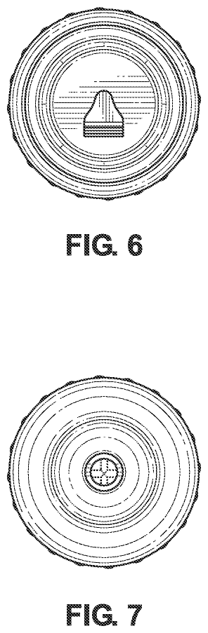

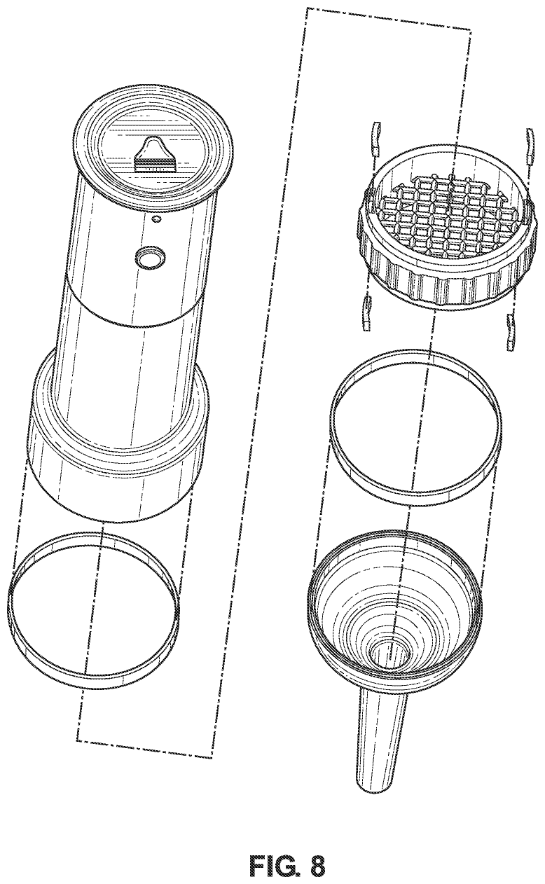

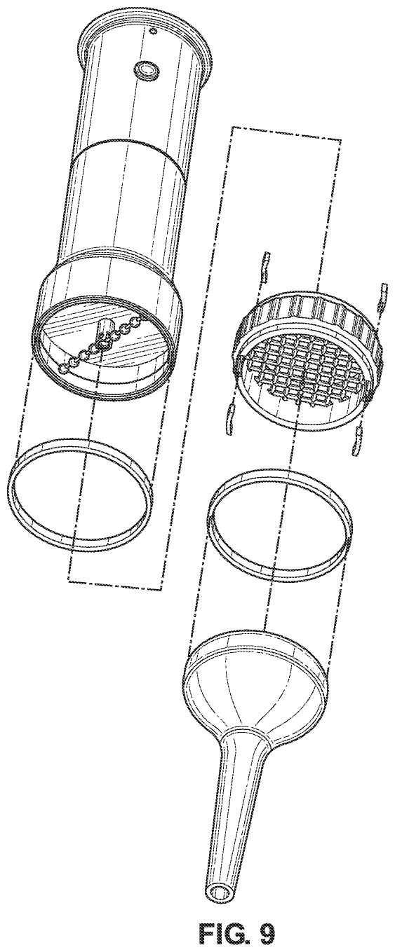

### DETAILS OF INVENTION

The invention described herein relates to a device for grinding a starting material and filling a receptacle with ground material.

In some embodiments, the device is self-packing, that is, the device grinds a starting material and fills a receptacle without the need for an additional or separate packing means, such as a tamper, loading arm, blender, mixer, spreader, or vibration means or otherwise manually packing the receptacle in some way. In some embodiments, the device grinds a starting material and fills a receptacle substantially simultaneously.

In some embodiments, the ground material is substantially a pre-determined particle size. In some embodiments, the starting material is preferably ground to obtain ground material with a particle size from about 0.1 mm to about 0.5 mm, or from about 1 mm to about 1.5 mm, or from about 3 mm to about 3.6 mm, or a particle size of about 3.6 mm or less, or about 3.5 mm or less, or about 3 mm or less, or about 2.5 mm or less, or about 2 mm or less, or about 1.5 mm or less, or about 1 mm or less, or about 0.5 mm or less.

In some embodiments, the starting material comprises agricultural or plant material, including, but not limited to, cannabis, hemp, tobacco, mushrooms, herbs, spices, botanical flowers, such as lavender, coffee, tea, or the like.

In some embodiments, the device includes a grinder portion 100 and a reservoir portion 300, wherein the reservoir portion can be removably attached, and wherein the reservoir portion is adapted to hold a desired receptacle to be filled directly from the grinder portion. In some embodiments, the device further includes a filter portion 200 between the grinder portion 100 and the reservoir portion 300.

In some embodiments, the device is a handheld or portable device. In some embodiments, the device is a handheld device and the largest diameter of the grinder portion 100 of the device is about 1 inch, or about 1.25 inches, or about 1.5 inches, or about 1.75 inches, or about 2 inches, or about 2.25 inches, or about 2.5 inches, or about 2.75 inches, or about 3 inches, or about 3.25 inches, or about 3.5 inches, or about 3.75 inches, or about 4 inches, or about 4.25 inches, or about 4.5 inches, or about 4.75 inches, or about 5 inches. In some embodiments, the device is a portable device that is not a handheld device and the largest diameter of the grinder portion 100 is greater than 5 inches, or about 4.25 inches, or about 4.5 inches, or about 4.75 inches, or about 5 inches, or about 5.25 inches, or about 5.5 inches, or about 5.75 inches, or about 6 inches, or about 6.25 inches, or about 6.5 inches, or about 6.75 inches, or about 7 inches, or about 7.25 inches, or about 7.5 inches, or about 7.75 inches, or about 8 inches, or about 8.25 inches, or about 8.5 inches, or about 8.75 inches, or about 9 inches, or about 9.25 inches, or about 9.5 inches, or about 9.75 inches, or about 10 inches, or about 10.25 inches, or about 10.5 inches, or about 10.75 inches, or about 11 inches, or about 11.25 inches, or about 11.5 inches, or about 11.75 inches, or about 12 inches or more.

In some embodiments, a grinder portion of the device 100 can be used for grinding, cutting, chopping, pulverizing, or otherwise breaking apart the starting material. The grinder portion of the device can rotate, spin, cut, break, and/or shred the starting material into smaller sizes. In some embodiments, the grinder can include a body configured to receive a starting material.

In some embodiments, the device disclosed herein includes a grinder portion 100 comprising a mechanical or manually operated grinder. In some embodiments, the grinder portion of the device 100 comprises an electric grinder.

In some embodiments, the device disclosed herein includes a grinder portion 100 comprising an electric grinder wherein the force of the electric grinding action creates a vortex that facilitates movement of ground material through an optional filter portion 200 into a reservoir portion 300 of the device.

When filling receptacles with ground material, it is often necessary to use tools or mechanisms to evenly distribute, or compress, or pack ground material into the receptacle. In some embodiments, the device disclosed herein is self-packing. In some embodiments, the vortex created by the electric grinder portion 100 facilitates movement of ground material through an optional filter portion 200 of the device into a reservoir portion 300 of the device. In some embodiments, the vortex created by the electric grinder portion 100 facilitates even distribution of ground material while filling a reservoir portion 300 of the device without the need for a packing means, such as a tamper, a blender, a mixer, a spreader, or a vibrating means. For example, in some embodiments, the vortex forces or shoots the ground material into the receptacle in the reservoir portion 300. In some embodiments, the vortex causes uniform filling and even distribution of ground material in the receptacle. In some embodiments, the vortex forces or shoots the ground material through an optional filter portion 200 before filling the reservoir portion 300.

In some embodiments, the grinder portion of the device 100 comprises an electric motor and includes one or more ball-and-chains, or chains, or blades, or teeth, or other similar cutting means connected to an axle or spindle driven by a motor. The one or more ball-and-chains, or chains, or blades, or other similar cutting means can be activated by an actuator that can operate as an on/off button, where the one or more ball-and-chains or blades can be connected to a spindle that is driven by a motor that is powered by a source, such as a lithium battery. More information about the grinder can be found in U.S. application Ser. No. 16/964,951, which claims priority to PCT/US2019/014964, filed on Jan. 24, 2019, the disclosure of which is fully incorporated by reference herein. The grinder portion of the device 100 further includes a printed circuit board (PCB). The PCB can function as a motherboard to control battery, motor and actuator on/off button of the device.

In some embodiments, the body of the grinder portion 100 includes a motor. In some embodiments, the motor can be actuated by the depression of a superior end of the body. In some embodiments, the motor can be deactivated by release of the superior end from its depressed position. In some embodiments, the motor can be deactivated be depressing the superior end while the motor is active.

In some embodiments, the motor can be actuated by depression of an on/off button on the device. In some embodiments, the motor can be deactivated by release of the on/off button from its depressed position. In some embodiments, the motor can be deactivated be depressing the on/off button while the motor is active.

In some embodiments, depression or pressing of the superior end of the grinder portion 100 towards the inferior end or depression of an on/off button can initiate an electrical connection between the motor and the power source. In some embodiments, the depression of the superior end towards the inferior end or depression of an on/off button can activate a switch. In some embodiments, release of the superior end or on/off button from its depressed position can deactivate the switch.

In some embodiments, the grinder portion 100 includes a power source such as a battery. In some embodiments, the power source can provide power to the motor. In some embodiments, the power source can be rechargeable. In some embodiments, the power source can be a rechargeable battery, such as a lithium-ion battery or the like. In some embodiments, the battery can be charged through inductive charging. In some embodiments, the power source can be charged through connection to a power cable.

In some embodiments, the grinder portion 100 includes a port configured to receive a power cable. In some embodiments, the power source can be charged through the port. In some embodiments, the port can be a USB port, a micro-USB port, a USB-C port, or any other suitable port. In some embodiments, the port can have an indicator light that indicates the status of the battery life or the charge. For example, in some embodiments, a red color illuminates while the device is charging and a light, such as white, red, orange, yellow, green, or blue light, illuminates once the device is fully charged.

The indicator light is an indication of the charge of the lithium battery in the device. The indicator light can have two colors. For example, after a full charge is achieved the indicator light will turn green and the indicator light will indicate red when in need of charge.

In some embodiments, the inner walls of the body of the grinder portion 100 defines an inner chamber at the inferior end of the grinder. In some embodiments, the grinder portion 100 includes one or more chains or blades or other cutting means. The one or more chains or blades or other cutting means can be rotated to grind, cut, chop, pulverize, or otherwise break apart materials positioned within the inner chamber. In some embodiments, the one or more chains or blades or other cutting means can be rotated to grind, cut, chop, pulverize, or otherwise break apart materials that enter the inner chamber as the opening of the body is advanced over the materials.

In some embodiments, the diameter of the one or more chains or blades or other cutting means is about 25 mm, or about 30 mm, or about 35 mm, or about 40 mm, or about 45 mm, or about 50 mm, or about 55 mm, or about 60 mm, or about 65 mm, or about 70 mm, or about 75 mm, or about 80 mm, or about 85 mm, or about 90 mm, or about 95 mm, or about 100 mm, or about 125 mm, or about 150 mm, or about 175 mm, about 200 mm, or about 225 mm, or about 250 mm, or about 275 mm, or about 300 mm. In some embodiments, the diameter of the one or more chains or blades or other cutting means is less than 100 mm. In some embodiments, the diameter of the one or more chains or blades or other cutting means is between 100 mm and 300 mm. In some embodiments, the diameter of the one or more chains or blades or other cutting means is more than 300 mm.

In some embodiments, the one or more chains can be a chain link, a ball chain, a cable chain, a rope chain, a box chain, and the like.

In some embodiments, the chain can be a cable chain comprising a classic Anchor cable link chain with simple oval or round links. The links connect each other horizontally and/or vertically. In some embodiments, the chain can be a fine anchor chain with small links (smaller than 2.5 mm) called a trace chain. In some embodiments, the chain can be a round link chain or a chain with connecting soldered round links. In some embodiments, the chain can be a flat link chain or a round basic link chain with connecting soldered flat round links. In some embodiments, the chain can be a twisted curb chain with twisted gourmet links. In some embodiments, the chain can be a figure eight or infinity chain having flat oval links combined with a smaller size infinity and/or 8-shaped links. In some embodiments, the chain can be a rolo or cascade or belcher chain comprising oval or round links that are typically flat on the inside and smaller and thicker than a basic link chain, giving the chain a heavy and sturdy appearance. In some embodiments, the chain can be a venetian link or box or briolette or square link chain made of flat-rolled plates that are formed into square cube links. In some embodiments, the chain can be a gourmet or Cuban link or curb chain which is a variation on the normal basic link chain, but the round or oval links are twisted and usually with a diamond cut. The links overflow into each other. In some embodiments, the chain can be a figaro chain, which has links similar to the gourmet chain but with a longer connecting link between every one to five gourmet links. The chain can have twisted links to create a woven rope effect.

In some embodiments, the chain can be a foxtail chain comprising a loop link chain that consists of two rows of oblique oval links. These links are connected by a series of flat rings in the middle of the chain. Each row is opposite each other at a 45-degree angle. This creates a braided or woven effect that gives the appearance of the hair on the tail of a fox.

In some embodiments, the chain can be a ball, bead, or pelline chain comprising balls instead of links. These round beads or balls can be solid or hollow to reduce weight. They can be attached at regular intervals along the length of the chain with connecting rods or placed directly next to each other.

In some embodiments, the chain can be a Saturn or satellite chain comprising a row of round links interspersed with beads. In some embodiments, the chain can be a Cardano or Boston link chain comprising a uniform series of rectangular decorative links that merge into each other. In some embodiments, the chain can be a wheat, palm, or Espiga chain comprising intertwined V-shaped links that create a woven rope effect. In some embodiments, the chain can be a Franco chain comprising intertwined V-shaped links with a square side profile. In some embodiments, the chain can be a bamboo chain comprising a row of cylindrical links interspersed with round beads. In some embodiments, the chain can be a herringbone chain comprising several rows of ‘v’ shaped flat links alternated with each new row to create the herringbone pattern. In some embodiments, the chain can be a cobra chain comprising a basic cable chain that is hammered or cut flat into a flat chain with flat triangular links. In some embodiments, the chain can be a Gucci, marine, or anchor chain comprising a repeated oval links arranged horizontally and vertically, usually with a vertical bar in the middle of each link. In some embodiments, the chain can be a Figarucci chain with twisted flat oval links and a vertical bar in the middle of each link.

In some embodiments, the chain can be a double link chain/parallel chain based on a basic link chain or round link chain but with double links. In some embodiments, the chain can be an elongated link chain based on a standard round link chain, but with elongated links instead of round links. In some embodiments, the chain can be a nugget, tinsel, or twisted serpentine chain with links that are soldered and hammered into a chain with collapsing ‘s’ shaped links, wherein the links are twisted a quarter turn. In some embodiments, the chain can be a Prince of Wales chain made of small round links interconnected with four others to resemble a rope with sturdy construction due to the extra connectivity between links. In some embodiments, the chain can be a San Marco chain comprising long and rounded links that look somewhat like macaroni placed side by side at a 45-degree angle. In some embodiments, the chain can be an omega chain comprising small individual round plates that lie next to each other. The omega chain is not completely round but hemisphere/flat round and there is an underlying wire or mesh to support these plates. In some embodiments, the chain can be a popcorn or coreana chain comprising concave-shaped links that are evenly distributed on each row.

In some embodiments, the chain can be a cascade chain comprising two ropes or round wire that are intertwined. In some embodiments, the chain can be a rope chain comprising small links intertwined and braided in two strands around each other. In some embodiments, the chain can be a Serpentine chain with hammered ‘s’ shaped links that overlap laterally. In some embodiments, the chain can be a snake, star weave, hexagon, Brazilian, or round maille chain comprising smooth round plates or rings with a slight bend in the middle that are closely connected to form a continuous flexible tube with a light zigzag effect. In some embodiments, the chain can be a Milano chain made of flat-rolled rings. In some embodiments, the chain can be a Singapore chain comprising a series of flat diamond-cut and diamond-shaped links twisted and flattened to form a chain. In some embodiments, the chain can be a Byzantine, idiot's delight, birdcage, or king's braid chain comprising links that are connected and folded back together in pairs vertically and horizontally and available in both flat, square and round styles. In some embodiments, the chain can be a book chain comprising links shaped like the bindings of books. In some embodiments, the chain can be a bar or link and bar chain comprising rods/bars interspersed with small rings. The bars can be smooth, separated by curving, decorative, elongated, hollow, shaped, solid, twisted. In some embodiments, the chain can be a railroad link chain comprising two continuous lines with cross bars. In some embodiments, the chain can be a mesh chain made from a very fine thread that is woven into a tubular chain. In some embodiments, the chain can be a heart link chain with connecting soldered heart-shaped links. In some embodiments, the chain can be a dragon link chain comprising intertwined V-shaped double links creating a braided or woven effect. In some embodiments, the chain can be a bike or bicycle chain comprising links inspired by a chain of a bicycle or motor vehicle. In some embodiments, the chain can be a cup chain (or tennis bracelet chain) comprising a series of square settings with glass crystals/zircon stones. The settings with stones are usually connected to each other with flat bars, so that the chain can move flexibly.

In some embodiments, the chain can be a Bismark chain made of two link chains with the sides soldered together to form a parallel link chain. In some embodiments, the chain can be a ladder or hook chain comprising a round link with two folded-back ends that form the hook that connects to the next link. In some embodiments, the chain can be a Marquis chain comprising links that are an elongated oval shape with pointed ends interspersed with simple rings. In some embodiments, the chain can be a panther chain comprising three or more rows of rectangular rounded links lying above each other with the center brick offset one half brick to the side. In some embodiments, the chain can be a ring and connector chain or a variation on the common link chain comprising elongated links connected to each other with rings. In some embodiments, the chain can be a peanut, tinsel, or crinkle chain comprising wavy peanut-shaped links. In some embodiments, the chain can be a scroll chain comprising twisted wire that forms links with a double curl or winding. In some embodiments, the chain can be a tile or rhombus link chain, a link chain with tile or diamond-shaped links.

The chain can be made of plastic, metal, steel, aluminum, gold, silver, brass, platinum and the like. This chain vary in widths, varying from a few millimeters to a few centimeters, and in length.

In some embodiments, the chain can be a metal ball chain or metal chain link. In some embodiments, the chain can be a steel ball chain or steel chain link. In some embodiments, the chain can be an aluminum ball chain or aluminum chain link. In some embodiments, the chain can be a polymer ball chain or polymer chain link. In some embodiments, the chain can be a plastic ball chain or plastic chain link. In some embodiments, the chain can be a nylon ball chain or nylon chain link.

In some embodiments, the length of the chain can be between 25 mm and 125 mm, between 30 mm and 100 mm, between 35 mm and 90 mm, between 40 mm and 80 mm, between 45 mm and 70 mm, between 10 mm and 70 mm, between 20 mm and 60 mm, between 30 mm and 50 mm, between 40 mm and 50 mm, or any other suitable length. In some embodiments, the length of the chain can be 10 mm, about 10 mm, 15 mm, about 15 mm, 20 mm, about 20 mm, 25 mm, about 25 mm, 30 mm, about 30 mm, 35 mm, about 35 mm, 40 mm, about 40 mm, 45 mm, about 45 mm, 45.5 mm, about 45.5 mm, 50 mm, about 50 mm, 55 mm, about 55 mm, 60 mm, about 60 mm, 65 mm, about 65 mm, 70 mm, about 70 mm, 75 mm, about 75 mm, 80 mm, about 80 mm, 85 mm, about 85 mm, 90 mm, about 90 mm, 95 mm, about 95 mm, 100 mm, about 100 mm, 105 mm, about 105 mm, 110 mm, about 110 mm, 115 mm, about 115 mm, 120 mm, about 120 mm, 125 mm, about 125 mm, or any other suitable length.

For example, in some embodiments, the chain can be a ball chain or a chain comprised of links. In some embodiments, the chain can include a plurality of balls and/or chain links. For example, in some embodiments, the chain can include one ball, two balls, three balls, four balls, five balls, six balls, seven balls, eight balls, nine balls, ten balls, eleven balls, twelve balls, thirteen balls, fourteen balls, fifteen balls, sixteen balls, seventeen balls, eighteen balls, nineteen balls, twenty balls, or any other suitable number of balls. In some embodiments, the chain can include between two balls and twenty balls, between five balls and fifteen balls, between seven balls and twelve balls, between eight balls and eleven balls, between seven balls and ten balls, between ten balls and fifteen balls, between fifteen balls and twenty balls, or any other suitable range.

In some embodiments, the balls or chain links can be round or generally round, spherical or generally spherical, oblong, cubic or generally cubic, rectangular or generally rectangular, polygonal, faceted, or any other suitable shape. In some embodiments, the balls or chain links can be hollow or substantially hollow. In some embodiments, the balls or chain links can be solid or substantially solid. In some embodiments, a hollow ball can connect two chains, and one or more of those chains can be connected to another hollow ball. In some embodiments, an open ball can be squeezed closed over a wire or string to form one of the balls of the chain.

In some embodiments, the balls can have a diameter between 0.5 mm and 10 mm, between 0.5 mm and 5 mm, between 5 mm and 10 mm, between 1 mm and 9 mm, between 2 mm and 8 mm, between 3 mm and 7 mm, between 4 mm and 6 mm, between 1 mm and 5 mm, between 1 mm and 4 mm, between 1 mm and 3 mm, between 1 mm and 2 mm, between 2 mm and 5 mm, between 2 mm and 3 mm, between 3 mm and 5 mm, between 3 mm and 4 mm, or any other suitable diameter.

In some embodiments, adjacent balls can be connected to one another by a link. In some embodiments, adjacent balls can be separated from one another by the link.

In some embodiments, the chain can be coupled to the motor via an axle or drive shaft. In some embodiments, the chain can be coupled to the motor via one or more gears. In some embodiments, a ball on a first end of the chain can be connected to the axle. In some embodiments, a ball in a center section of a chain can be connected to the axle. In some embodiments, the motor can be activated to cause the chain to undergo circular or rotational motion. In some embodiments, the motor can be activated to cause the chain to undergo reciprocal motion. In some embodiments, the circular or rotational motion creates a vortex.

In some embodiments, the links of a ball chain can form spaces between each ball within which the ball can move back and forth on the link to facilitate cutting actions at multiple points and multiple sizes. In some embodiments, the links of a chain link can move back and forth to facilitate cutting actions at multiple points and multiple sizes. In some embodiments, when activated, the chain can cause a whiplash effect or a curling effect as the chain wraps around materials that enter the inner chamber as the opening of the body is advanced over the materials. In some embodiments, when activated, the chain creates a vortex.

In some embodiments, the space between balls or links in a chain can be minimized (e.g., no spacing, enough spacing to permit the chain to flex, or larger spacing). For example, in some embodiments, the space between adjacent balls can be between 0 mm and 20 mm, between 0.5 mm and 10 mm, between 0.5 mm and 5 mm, between 5 mm and 10 mm, between 1 mm and 9 mm, between 2 mm and 8 mm, between 3 mm and 7 mm, between 4 mm and 6 mm, between 1 mm and 5 mm, between 1 mm and 4 mm, between 1 mm and 3 mm, between 1 mm and 2 mm, between 2 mm and 5 mm, between 2 mm and 3 mm, between 3 mm and 5 mm, between 3 mm and 4 mm, or any other suitable distance. In some embodiments, the link between the balls can be rigid (e.g., a rod or wire). In some embodiments, the link between the balls can be flexible (e.g., a string of polymeric material).

In some embodiments, the grinder portion of the device 100 comprises an electric motor and includes one or more blades. In some embodiments, the one or more blades are made out of any type of metal such as steel, titanium, aluminum. In some embodiments, the one or more blades are made of plastic material, connected to an axle or spindle driven by a motor. The blades can be activated by an actuator that can operate as an on/off button, where the blades can be connected to a spindle that is driven by a motor that is powered by a source, such as a lithium battery.

In some of the embodiments the one or more blades can come in different shapes and sizes. For example, in some embodiments the blades can be a cross shape, the blades cut through the material to pack the cone. In some embodiments the blades can be a straight horizontal bar made of metal or plastic. In some embodiments the blades can be in the shape of a banana, called banana-shaped blades, and can be made of metal, plastic, or any other material that can chop down material.

In some embodiments, the one or more blades have sharp edges to cut and chop. In some embodiments, the one or more blades can have no sharp edges. In some embodiments, the one or more blades comprise a piece of metal or plastic spinning at high revolutions to chop and cut.

In some embodiments the blades can come in different lengths and thickness. In some embodiments, a metal bar is used as a blade. In some embodiments, a plastic bar is used as a blade.

In some of the embodiments there can be one or more sets of blades attached to the spindle. A row of blades can be attached to the spindle, with multiple blades stacked to cut and chop.

In some embodiments, the one or more blades comprise a circular disc having a plurality of openings or holes to grind or chop the material. In some embodiments, the plurality of openings or holes are circular or substantially circular in shape. In some embodiments, the plurality of openings or holes are oval or substantially oval in shape. In some embodiments, the plurality of openings or holes are kidney bean shaped. In some embodiments, the plurality of openings or holes are triangular or substantially triangular in shape. In some embodiments, the plurality of openings or holes are square or substantially square in shape. In some embodiments, the plurality of openings or holes are rectangular or substantially rectangular in shape. In some embodiments, the plurality of openings or holes are diamond or substantially diamond in shape. In some embodiments, the plurality of openings or holes are polygon, such as, but not limited to, pentagon, hexagon, octagon, or substantially polygon in shape. In some embodiments, the plurality of openings or holes are all the same shape. In some embodiments, the plurality of openings or holes are different shapes.

In some embodiments, the grinder portion of the device 100 includes one or more sensors. In some embodiments, the grinder portion 100 includes one or more sensors configured to detect an orientation of the grinder. In some embodiments, the device can be configured to deactivate the motor if a bottom edge of the grinding portion 100 is not positioned at a predefined orientation. In some embodiments, the predefined orientation is directly over the materials, that is, perpendicular to the plane of the surface of the materials with the opening of the device 100 facing down. In some embodiments, the predefined position is upside down, that is the opening of the device 100 facing up.

In some embodiments, the grinder portion 100 can communicate with one or more external devices via wireless or Bluetooth connectivity.

In some embodiments, the body of the grinder portion 100 of the device is removably coupled or attached to an optional filter portion 200 of the device. In some embodiments, a superior end of the filter portion 200 is removably coupled or attached to an inferior end of the body of the grinder portion 100. For example, the filter portion 200 can have an attachment means to attach to the grinder portion 100.

In some embodiments, the attachment means comprises one or more magnets in combination with one or more stainless steel pieces. For example, in some embodiment, the filter portion 200 can have one or more magnets in a superior end that removably attach to one or more steel pieces in an inferior end of the body of the grinder portion 100. In some embodiments, the filter portion 200 comprises one, two, three, four, five or more magnets at the superior end. In some embodiments, the filter portion 200 comprises a magnet ring in the superior end. In some embodiments, the inferior end of the body of the grinder portion 100 comprises one, two, three, four, five or more steel pieces that removably attach to the one or more magnets in the superior end of the filter portion 200. In some embodiments, the inferior end of the body of the grinder portion 100 comprises a steel ring that removably attaches to the one or more magnets in the superior end of the filter portion 200.

In some embodiments, the filter portion 200 has a “female slot” that attaches to a “male slot” in the grinder portion 100. In this way the filter portion 200 can be removably attached to the device by sliding the male and female slot together by a clockwise or counterclockwise twisting action. Other means of removably coupling the filter portion 200 and the grinder portion 100 will be apparent to those of skill in the art.

In some embodiments, a starting material is placed on top of a filter or a grate of the filter portion 200 which is then removably attached to an inferior end of the body of the grinder portion 100. In some embodiments, the grinder portion 100 grinds the starting material and the filter portion 200 allows only ground material smaller than a pre-determined particle size to pass through the filter portion 200 to a reservoir portion 300.

In some embodiments, in the case of an electric grinder, the grinder portion 100 can be depressed inferiorly towards the removably attached filter portion 200 to activate the grinder. In some embodiments, the grinder portion 100 can be released from its depressed position to deactivate the grinder.

In some embodiments, the filter or grate of the filter portion 200 is round in outer shape. In some embodiments, the filter portion 200 can have a 1-inch diameter, or a 1.25-inch diameter, or a 1.5-inch diameter, or a 1.75-inch diameter, or a 2-inch diameter, or a 2.25-inch diameter, or a 2.5-inch diameter, or a 2.75-inch diameter, or a 3-inch diameter.

The depth of the filter portion 200 can vary. In some embodiments, the filter portion 200 has a depth of between 5 mm and 100 mm, between 10 mm and 50 mm, between 15 mm and 25 mm, between 20 mm and 30 mm, between 15 mm and 70 mm, between 10 mm and 70 mm, between 15 mm and 60 mm, between 10 mm and 50 mm, between 5 mm and 40 mm, or any other suitable depth. In some embodiments, the filter portion 200 has a depth of 5 nm, about 5 nm, 10 nm, about 10 nm, 15 nm, about 15 nm, 20 nm, about 20 nm, 25 nm, about 25 nm, 30 nm, about 30 nm, 40 nm, about 40 nm, 50 nm, about 50 nm, 55 mm, about 55 mm, 60 mm, about 60 mm, 65 mm, about 65 mm, 70 mm, about 70 mm, 75 mm, about 75 mm, 80 mm, about 80 mm, 85 mm, about 85 mm, 90 mm, about 90 mm, 95 mm, about 95 mm, 100 mm, about 100 mm, or any other suitable depth.

In some embodiments, the filter or grate of the filter portion 200 of the device can include a plurality of openings of various sizes and in various patterns configured to allow only particle sizes smaller than a pre-determined size to pass through the filter or grate after being ground or shredded by the grinder portion 100. For example, in some embodiments, the filter or grate of the filter portion 200 can have a pattern of one or more squares, or one or more diamonds, or one or more circles, or one or more ovals, or one or more rectangles, or any combination thereof. In some embodiments, the pattern is configured to allow only particles smaller than a pre-determined particle size to pass through the filter portion 200 after being shredded or ground by the grinder portion 100. In some embodiments, the pre-determined particle size is about 0.1 mm to about 0.5 mm, or from about 1 mm to about 1.5 mm, or from about 3 mm to about 3.6 mm, or a particle size of about 3.6 mm or less, or about 3.5 mm or less, or about 3 mm or less, or about 2.5 mm or less, or about 2 mm or less, or about 1.5 mm or less, or about 1 mm or less, or about 0.5 mm or less.

In some embodiments, the filter portion 200 is formed, as by molding, of a suitable plastic material which is resistant to high heat so that it can be cleaned in a dishwasher. Suitable materials may include nylon, acrylonitrile butadiene styrene (ABS) plastic, high-density polyethylene fibers (HDPE) or Tyvek® plastic, thermoplastic, or polypropylene and the like.

In some embodiments, the filter portion 200 allows ground, broken, and/or shredded material to pass through a filter or grate. In some embodiments, the filter or grate can have a plurality of square-shaped openings to allow ground material to pass through once it is below a pre-determined size. In some embodiments, the filter portion 200 can serve as a barrier and a surface for the starting material to be placed on for the purpose of grinding and shredding by the grinder portion 100.

In some embodiments, the device described herein further comprises a reservoir portion 300 that can be removably attached or coupled to the filter portion 200. In some embodiments, the reservoir portion 300 is molded or otherwise adapted to hold a pre-formed container or receptacle into which the ground material of sufficiently small particle size accumulates after passing through the filter portion 200. Exemplary pre-formed containers include, but are not limited to, pods, pre-formed cones for smoking, spice jars, capsules, and the like.

In some embodiments, an inferior end of the filter portion 200 is removably attached or coupled to an inferior end of a reservoir portion 300. For example, the reservoir portion 300 can have an attachment means to attach to the filter portion 200.

In some embodiments, the attachment means comprises one or more magnets in combination with one or more stainless steel pieces. For example, in some embodiment, the filter portion 200 can have one or more magnets in an inferior end that removably attach to one or more steel pieces in a superior end of the reservoir portion 300. In some embodiments, the filter portion 200 comprises one, two, three, four, five or more magnets at the inferior end. In some embodiments, the filter portion 200 comprises a magnet ring in the inferior end. In some embodiments, the superior end of the reservoir portion 300 comprises one, two, three, four, five or more steel pieces that removably attach to the one or more magnets in the inferior end of the filter portion 200. In some embodiments, the superior end of the reservoir portion 300 comprises a steel ring that removably attaches to the one or more magnets in the inferior end of the filter portion 200.

In some embodiments, the reservoir 300 portion has a “female slot” that attaches to a “male slot” in the filter portion 200. In this way the reservoir portion 300 can be removably attached to the device by sliding the male and female slot together by a clockwise or counterclockwise twisting action. Other means of removably coupling the filter portion 200 and the reservoir portion 300 will be apparent to those of skill in the art.

Removably coupling the grinder portion 100, filter portion 200 and reservoir portion 300 forms the device disclosed herein and ensures that no starting material being ground by the grinder portion 100 escapes the device.

In some embodiments, the body of the grinder portion 100 of the device is removably coupled or attached to a reservoir portion 300 of the device without the use of a filter portion 200. In some embodiments, a superior end of the reservoir portion 300 is removably coupled or attached to an inferior end of the body of the grinder portion 100. For example, the reservoir portion 300 can have an attachment means to attach to the grinder portion 100.

In some embodiments, the attachment means comprises one or more magnets in combination with one or more stainless steel pieces. For example, in some embodiment, the reservoir portion 300 can have one or more magnets in a superior end that removably attach to one or more steel pieces in an inferior end of the body of the grinder portion 100. In some embodiments, the reservoir portion 300 comprises one, two, three, four, five or more magnets at the superior end. In some embodiments, the reservoir portion 300 comprises a magnet ring in the superior end. In some embodiments, the inferior end of the body of the grinder portion 100 comprises one, two, three, four, five or more steel pieces that removably attach to the one or more magnets in the superior end of the reservoir portion 300. In some embodiments, the inferior end of the body of the grinder portion 100 comprises a steel ring that removably attaches to the one or more magnets in the superior end of the reservoir portion 300.

In some embodiments, the reservoir portion 300 has a “female slot” that attaches to a “male slot” in the grinder portion 100. In this way the reservoir portion 300 can be removably attached to the device by sliding the male and female slot together by a clockwise or counterclockwise twisting action. Other means of removably coupling the reservoir portion 300 and the grinder portion 100 will be apparent to those of skill in the art.

In some embodiments, a starting material is placed in the grinder portion 100 which is then removably attached to the reservoir portion 300. In some embodiments, the grinder portion 100 grinds the starting material in an upside down orientation and is then flipped right side up after grinder thereby allowing ground material to pass into the reservoir portion 300.

In some embodiments, the reservoir 300 portion comprises a holder for a pod to be filled with ground material, such as a Keurig pod. In some embodiments, the reservoir portion 300 comprises a holder for a container to be filled with ground spices. In some embodiments, the reservoir portion 300 comprises a holder for a capsule to be filled with ground plant matter or plant medicine. In some embodiments, the reservoir portion 300 comprises a holder for pre-rolled rolling papers or cones to be filled with ground tobacco or hemp or cannabis.

In some embodiments, the device is for grinding cannabis, or tobacco, or flower botanicals such as lavender, and the like, and the reservoir portion 300 is adapted to hold a cone to be filled by the ground material for smoking.

In some embodiments, the reservoir portion 300 comprises a cone holder molded to hold pre-formed cones in place to be filled with ground material passing directly from the grinder portion 100 to the reservoir portion 300, or from the grinder portion 100 through the filter portion 200 to the reservoir portion 300 of the device. In some embodiments, the cone holder can be made of polycarbonate plastic, metal, or other similar materials able to be molded to hold cones of various dimensions.

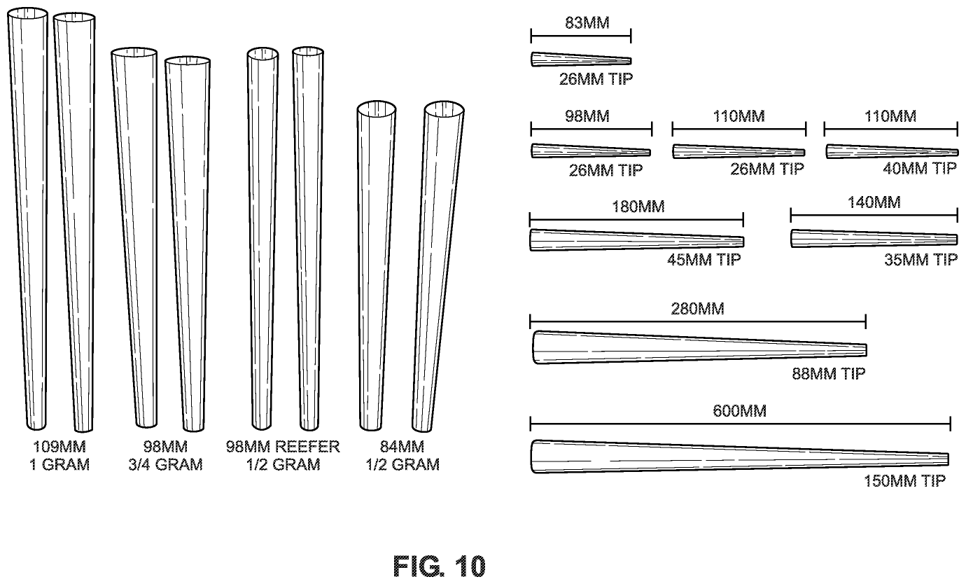

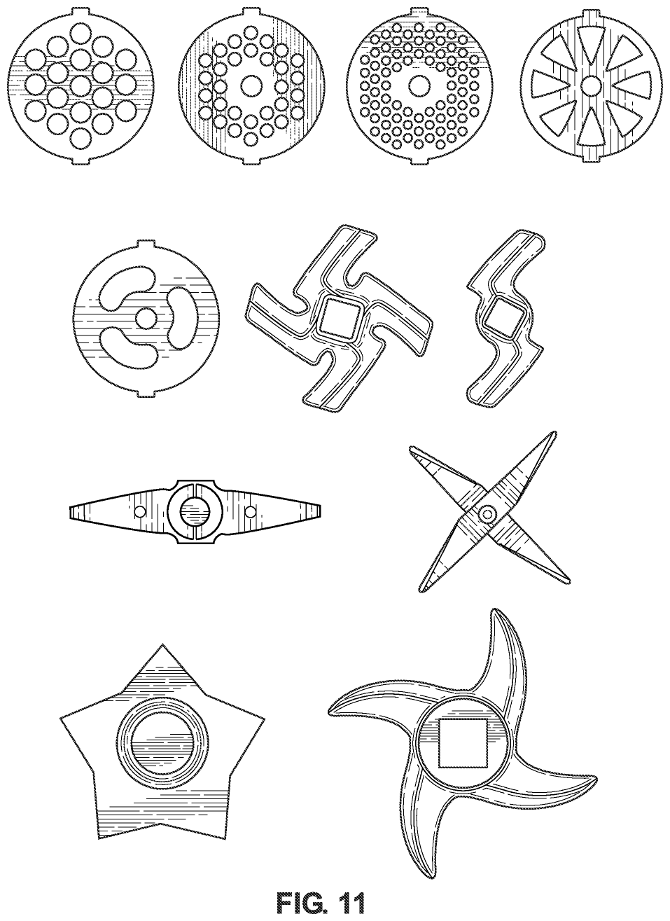

As used herein a “cone” refers to a type of pre-formed rolling paper or joint that is more conical than a typical joint or cigarette. The cone can be made of different materials, such as hemp, paper, tobacco, banana leaf, and other similar materials that can be made to form a conical shape and able to be smoked. In some embodiments, the cone starts straight and thin and widens as the cone gets longer as illustrated in FIG. 10. As shown in FIG. 10, the cone start (or tip) ranges in size from 26 mm to 150 nm, or from 26 mm to 88 mm, or from 35 mm to 45 mm. In some embodiments, the cone tip is 26 mm, or 35 mm, or 40 mm, or 45 mm, or 88 mm, or 150 mm. In some embodiments, cones can come in various lengths, including, but not limited to, 83 mm, 98 mm, 110 mm, 140 mm, 180 mm, 280 mm, or 600 mm. For example, a 1¼ cone has a 26 mm tip, is 83 mm in length and holds 0.75 grams of ground material; a “98 special” has a 21 mm tip, is 98 mm in length, and holds 1 gram of ground material, a “lean” has a 40 mm tip, is 100 mm in length and holds 0.75 grams; a “king size” has a 26 mm tip, is 110 mm in length and holds 1.5 grams; a “peacemaker” has a 35 mm tip, is 140 mm in length, and holds 2.25 grams of ground material; an “emperador” has a 445 mm tip, is 180 mm in length, and holds 4 grams of ground material; a “supernatural” has an 99 mm tip, is 280 mm in length, and holds 20 grams of ground material, and a “challenge” has a 150 mm tip, is 600 mm in length, and holds 3 ounces or 85 grams of ground material. In some embodiments, cones hold about 3 ounces, about 2.5 ounces, about 2 ounces, about 1.5 ounce, about 1 ounce, about 0.5 ounce, about 28 grams, about 20 grams, about 14 grams, about 10 grams, about 5 grams, about 4 grams, about 3.75 grams, about 3.5 grams, about 3.25 grams, about 3 grams, about 2.7 g grams, about 2.5 grams, about 2.25 grams, about 2 grams, about 1.75 grams, about 1.5 grams, about 1.25 grams, about 1 gram, about 0.75 gram, about 0.5 gram, or about 0.25 gram of ground material.

In some embodiments, the reservoir portion 300 comprises a cone holder adapted to hold a preformed cone of one or more particular sizes and/or dimensions. In some embodiments, the device comprises multiple adapters and/or multiple cone holders each adapted to hold a performed cone of a different size and/or dimension. In some embodiments, the cone holder is tapered thereby having a plurality of different diameter dimensions to accommodate cones of different sizes and/or dimensions.

In some embodiments, the superior end of the reservoir portion 300 is shaped to be conducive to receiving ground material and directing it toward the desired receptable. A wide variety of shapes and sizes can be used. For example, in some embodiments, a funnel shape can be used. A funnel shape typically includes a relatively wide-mouthed upper bowl region and a narrow spout opening designed to funnel ground material into the receptacle held in the inferior end of the reservoir portion. In some embodiments, the spout is tapered. In some embodiments, the reservoir portion 300 is substantially circular in transverse cross section with a continuously curved longitudinal cross-sectional shape of variable slope, and includes a relatively large-diameter upper bowl, the lower end of which is joined by a tapered neck to a receptacle held in the inferior end of the reservoir portion 300. In some embodiments, the reservoir portion 300 is shaped to match the receptacle without a funnel portion.

In some embodiments, the reservoir portion 300 is formed, as by molding, of a suitable plastic material which is resistant to high heat, so that it can be cleaned in a dishwasher. Suitable materials may include nylon, acrylonitrile butadiene styrene (ABS) plastic, high-density polyethylene fibers (HDPE) or Tyvek® plastic, thermoplastic, or polypropylene and the like.

In some embodiments wherein the receptacle is a pre-formed cone, a cone is inserted into a reservoir portion 300 comprising a cone holder. In some embodiments, an inferior edge of the cone holder terminates at a narrow end to define a narrow outlet opening and the tip of the cone is exposed at the inferior edge of the reservoir portion 300 after it is inserted.

In some embodiments, a smoking filter is included inside the cone prior to removably attaching the reservoir portion 300 to the filter portion 200 to prevent ground material from falling out of the bottom of the cone. Smoking tips serve as a filter and/or a barrier between ground material for smoking, such as cannabis or tobacco, and a user's lips. In some embodiments, smoking tips are cardboard, but can be glass, or can be made of other materials. Smoking tips can come in different dimensions such as length and diameter.

In some embodiments, once the cone is filled to the top, the user disengages the reservoir portion 300 from the grinder portion 100 or from the optional filter portion 200 of the device, if used, and gently taps the bottom of the reservoir portion 300 on a hard surface to dislodge the cone from the reservoir portion 300 to be removed for use. In some embodiments, the user gently taps the reservoir portion 300 of the device on a hard surface to pack the ground material into the receptacle inside the reservoir portion 300. The user then removes the cone from the reservoir portion 300 for use.

In some embodiments, the reservoir portion 300 can be used independent of the grinder portion 100 and/or filter portion 200. In some embodiments, ground material can be loaded into the reservoir portion 300 from any grinding means, such as manually grinding using fingers, using a rotary grinder, such as one made of acrylic, wood, or metal, using a multi-chamber grinder, using an electric grinder, and the like. In some embodiments, ground material is loaded into the wide opening of the reservoir portion 300 and allowed to funnel into a receptacle in the inferior end of the reservoir portion 300. In some embodiments, the receptacle in the inferior end of the reservoir portion 300 is cone in the cone. In some embodiments, the reservoir portion 300 is sold separately from the grinder portion 100 and/or optional filter portion 200.

Some embodiments herein relate to a method of grinding a starting material and uniformly filling a receptacle with ground material of substantially similar particle size without the use of a packing tool, such as a tamper, a blender, a mixer, or a vibration device, using the device disclosed herein. In operation, a user chooses an appropriate reservoir portion 300 of the device and inserts a pre-formed receptacle to be filled. The user then removably engages the superior end of the reservoir portion 300 to the inferior end of the grinder portion 100 or the inferior end of the optional filter portion 200, if used, for example, by twisting clockwise or by engaging magnets in the two portions. If an optional filter portion 200 is used, material to be ground is placed on top of a filter or grate in the filter portion 200 and the superior end of the filter portion 200 is removably attached to the inferior end of the grinder portion 100, for example, by twisting clockwise or by engaging magnets in the two portions. If an optional filter portion 200 is not used, material to be ground is placed directly into the grinder portion 100. The user then engages the grinder portion 100, such as by pressing the superior end or by pressing an on/off switch or button, to activate a motor attached to one or more chains or blades thereby grinding the starting material into smaller dimensions. If the optional filter portion 200 is used, the filter portion 200 allows only particles smaller than the pre-determined particle size to pass through to the reservoir portion 300 thereby filling the receptacle. The vortex created by the one or more chains or blades of the electric grinder in the grinder portion 100 creates a vortex that uniformly and evenly distributes ground material in the receptacle without the use of a packing means, such as a tamper, or blender, or mixer, or spreader, or vibration means. If the optional filter portion 200 is not used the orientation of the device can be changed, such as from inverted to right side up to move ground material from the grinder portion 100 to the reservoir portion 300. Once the receptacle is filled, the user disengages the reservoir portion 300 from the grinder portion 100 or from the optional filter portion 200, if used, for example, by twisting counter-clockwise or by disengaging magnets in the two portions, and removes the receptacle filled with ground material.

In some embodiments, the inferior end of the reservoir portion 300 comprises a cone holder for holding a pre-formed cone inside the reservoir portion 300 of the device. The cone holder holds the cone in place and is filled with ground material received from the grinder portion 100. In some embodiments, the reservoir portion 300 is designed such that a pre-formed cone in the inferior end can be filled uniformly without the need for a packing means.

In some embodiments an objective of the device is to grind a starting material by utilizing the one or more ball-and-chains or blades in a spinning fashion driven by the motor on an axle in order to grind material to a consistent size that will pass through a filter or grate of a certain dimensions and in order to create vortex that will facilitate even distribution of the ground material in a receptacle after passing through the filter or grate. In some embodiments, the device herein uniformly fills the receptacle in the reservoir portion. In some embodiments, the device herein substantially simultaneously grinds the starting material and uniformly fills the receptacle in the reservoir portion.

### EXAMPLES

### Example 1

A device according to the description herein was used to grind cannabis and fill cones of various sizes. Briefly, various cultivars (or strains) of high-quality sticky cannabis buds were placed on top of the superior end of the filter portion 200 and the superior end of the filter portion 200 was removably attached to the inferior end of the grinder portion 100. A 1¼ cone having a 26 mm tip and 83 mm in length was inserted into the reservoir portion 300 and the superior end of the reservoir portion was removably attached to the inferior end of the filter portion 200. The grinder portion 100 was then activated and the time to fill 1¼ cones was observed.

The device uniformly filled 1¼ cones no matter what starting material without the need for any tamping or additional packing means, and continued filling 1¼ cones at a consistent rate until the battery needed to be recharged. The average time observed to fill 1¼ cones was three (3) seconds. The average amount filled per cone was 0.75 grams. A uniform distribution of ground material was observed in all cases and was confirmed by an even burn with proper/unrestricted air flow.

### Example 2

The experiment above was repeated but using king size cones having a 26 mm tip and 110 mm in length instead of 1¼ inch cones.

The device uniformly filled king size cones no matter what starting material without the need for any tamping or additional packing means, and continued filling king size cones at a consistent rate until the battery needed to be recharged. The average time observed to fill king size cones was five (5) seconds. The average amount filled per cone was 1.5 grams. A uniform distribution of ground material was observed in all cases and was confirmed by an even burn with proper/unrestricted air flow.

### Example 3

A device according to the description herein is used to grind coffee beans and fill Keurig pods. Briefly, various types of coffee beans are placed on top of the superior end of the filter portion 200 and the superior end of the filter portion 200 is removably attached to the inferior end of the grinder portion 100. A Keurig pod is inserted into the reservoir portion 300 and the superior end of the reservoir portion is removably attached to the inferior end of the filter portion 200. The grinder portion 100 is then activated and the filling of Keurig pods is observed.

The device uniformly fills Keurig pods no matter what starting material without the need for any mixing or additional packing means and continues filling Keurig pods at a consistent rate until the battery needed to be recharged. A uniform distribution of ground material inside the Keurig pod is observed in all cases.

### Example 4

A device according to the description herein is used to grind dried mushrooms and fill pill capsules. Briefly, various types of dried mushrooms are placed on top of the superior end of the filter portion 200 and the superior end of the filter portion 200 is removably attached to the inferior end of the grinder portion 100. A pill capsule is inserted into the reservoir portion 300 and the superior end of the reservoir portion is removably attached to the inferior end of the filter portion 200. The grinder portion 100 is then activated and the filling of capsules is observed.

The device uniformly fills capsules no matter what starting material without the need for any mixing or additional packing means and continues filling capsules at a consistent rate until the battery needed to be recharged. A uniform amount distribution of ground material inside the capsules is observed in all cases.

### Example 5

A device according to the description herein is used to grind dried herbs and fill spice jars. Briefly, various types of dried herbs and spices are placed on top of the superior end of the filter portion 200 and the superior end of the filter portion 200 is removably attached to the inferior end of the grinder portion 100. Ajar is inserted into the reservoir portion 300 and the superior end of the reservoir portion is removably attached to the inferior end of the filter portion 200. The grinder portion 100 is then activated and the filling of spice jars is observed.

The device uniformly fills jars no matter what starting material without the need for any mixing or additional packing means and continues filling jars at a consistent rate until the battery needed to be recharged. A uniform amount and distribution of ground material inside the jars is observed in all cases.

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1-21. (canceled)

22. A combination grinding and filling device comprising a grinder portion comprising one or more chains coupled to a motor and capable of circular or rotational motion, wherein the grinder portion can be removably attached to a reservoir portion, wherein the reservoir portion is adapted to hold a desired receptacle to be filled with a ground material received from the grinder portion.

23. The device of claim 22, wherein the receptacle to be filled with ground material is a pre-formed cone.

24. The device of claim 22, wherein the receptacle to be filled with ground material is a spice jar.

25. The device of claim 22, wherein the one or more chains can comprise a plurality of balls and chain links.

26. The device of claim 22, wherein the one or more chains comprise links inspired by a chain of a bicycle.

27. The device of claim 22, wherein the one or more chains are between 25 mm and 125 mm in length.

28. The device of claim 22, wherein the circular or rotational motion creates a vortex in the device that facilitates movement of ground material from the grinder portion to the receptacle in the reservoir portion.

29. The device of claim 28, wherein the vortex uniformly and evenly distributes ground material in the receptacle.

30. The device of claim 22, further comprising a filter portion removably attached between the grinder portion and the reservoir portion.

31. The device of claim 22, wherein the device is a handheld device.

32. The device of claim 22, wherein the reservoir portion is adapted to hold two or more desired receptacles.

33. A method of grinding a starting material and filling a receptacle with ground material comprising:
obtaining a starting material to be ground;
placing the starting material in the grinder portion of the device of claim 1;
placing a desired receptacle into the reservoir portion of the device of claim 1;
removably attaching the reservoir portion to the grinder portion;
positioning the grinder portion such that the one or more cutting means contact the starting material;
activating the grinder portion to cause rotational or reciprocal motion of the one or more chains within the grinder portion;
disengaging the reservoir portion from the grinder portion; and
removing the receptacle filled with ground material.

34. The method of claim 33, wherein the receptacle is a pre-formed cone.

35. The method of claim 33, wherein the receptacle is a spice jar.

36. The method of claim 33, wherein the method further comprises removably attaching a filter portion between the grinder portion and the reservoir portion, wherein the starting material is placed between the grinder portion and the filter portion.

37. The method of claim 33, wherein the rotational or reciprocal motion of the one or more chains within the grinder portion creates a vortex in the device that facilitates movement of ground material from the grinder portion to the receptacle in the reservoir portion.

38. The method of claim 37, wherein the vortex uniformly and evenly distributes ground material in the receptacle without the need for a tamper, or blender, or mixer, or spreader, or vibration means.

39. The method of claim 33, wherein the receptacle is filled with ground material without the need for an additional or separate packing means.

40. The method of claim 33, wherein activating the grinder portion results in grinding of the starting material and filling of the receptacle in the reservoir with ground material substantially simultaneously.

41. The method of claim 33, wherein the device of claim 1 is a handheld device.
